(19) United States
(12) Patent Application Publication
(10) Pub. No.: US 2008/0228552 A1
(43) Pub. Date: Sep. 18, 2008

(54) System and method for providing product recommendations to consumers within a merchant location

(75) Inventor: Geoffry A. Westphal, Park Ridge, IL (US)

Correspondence Address: GREENBERG TRAURIG, LLP, 77 WEST WACKER DRIVE, SUITE 2500, CHICAGO, IL, 60601-1732, US

(73) Assignee: W.W. Grainger, Inc., Lake Forest, IL (US)

(21) Appl. No.: 11/518,799

(22) Filed: Sep. 11, 2006

(51) Int. Cl. G06Q 30/00; G06F 17/30; G06Q 90/00

(52) U.S. Cl. 705/10; 705/500

(57) ABSTRACT

Discerned relationships between products are utilized to generate product recommendation cards that are to be positioned throughout a merchant location. The product recommendation card contains information about one or more products that are likely to be purchased with a related-to product. The information carried on the product recommendation card may include one or more of the following for a recommended product: an image of the product; a brand for the product; a logo associated with the product; a textual description of the product; a bar code associated with the product; usage information for the product; and a location of the product within the merchant location. The product recommendation card(s) for product(s) that are likely to purchased with a related-to product may then be positioned in the vicinity of the related-to product within the merchant location to draw the attention of the consumer to these product(s) for the purpose of causing the consumer to purchase these product(s) in addition to the related-to product.

### BACKGROUND

This following generally relates to product merchandising and, more particularly, relates to a system and method for providing product recommendations to consumers within a merchant location.

In the art there exists a number of business websites that allow a consumer to purchase products online. At various times during the online purchasing process, the websites may offer recommendations of other products that the consumer may also be interested in purchasing. These recommendations can serve not only to increase sales, but also to drive awareness that the merchant carries a particular product or brand. Representative systems for discerning products to recommend and/or to provide online product recommendations are disclosed in U.S. Pat. Nos. 6,782,370, 6,912,505, 6,317,722, 6,266,649, 6,064,980, and 6,963,848 as well as U.S. Published Application Nos. 2005/0171860 and 2005/0171855.

It is also known in the art to generally direct consumers to product locations within a store. For example, U.S. Published Application No. 2002/0065714 discloses a system that provides directions to a consumer requesting information about the location of a product in a store. The directions provided to the consumer are also used to bring the consumer into the vicinity of other products in which the consumer may have an interest in purchasing. A kiosk accepts input that identifies the product of interest as well as the consumer. The identity of the consumer is used to further identify the other products that may be of interest to the consumer. The location of the product identified as being of interest to the consumer and the location of the kiosk where the data was entered define an endpoint and a starting point for the consumer's path, respectively, with the locations of the other products identified as being of possible interest to the consumer being used to define that path through the store from the staring point to the endpoint.

Still further, it is known in the art to group products within a location within a store that are likely to be purchased together by a consumer. For example, it is common for a supermarket to place together within a supermarket aisle both beer and chips.

While these known systems and methods do work for their intended purpose, it is seen that a need remains in the art for an improved system and method for providing product recommendations particularly to consumers within a merchant location.

### SUMMARY

To address this need, the following describes a system and method for recommending products to consumers within a merchant location. The system and method utilizes discerned relationships between products to generate product recommendation cards that are to be positioned throughout the merchant location. Generally, a product recommendation card is an information card that may contain information about one or more products that are likely to be purchased with another product, i.e., their related-to product. By way of example and without limitation, the information carried on a product recommendation card may include one or more of the following for a recommended product: an image of the product; a brand for the product; a logo associated with the product; a textual description of the product; a bar code associated with the product; usage information for the product; and a location of the product within the merchant location. The product recommendation card(s) for product(s) that are likely to purchased with a related-to product may then be positioned in the vicinity of the related-to product within the merchant location to draw the attention of the consumer to these product(s) for the purpose of causing the consumer to purchase these product(s) in addition to the related-to product.

A better understanding of the objects, advantages, features, properties and relationships of the system and method for providing product recommendations will be obtained from the following detailed description and accompanying drawing that set forth illustrative embodiments that are indicative of the various ways in which the principles expressed hereinafter may be employed.

### BRIEF DESCRIPTION OF THE DRAWINGS

For a better understanding of the system and method for providing product recommendations reference may be had to preferred embodiments shown in the following drawings in which:

FIG. 1 illustrates a floor plan of an exemplary merchant location;

FIG. 2 illustrates an exemplary product recommendation card; and

FIG. 3 illustrates use of exemplary product recommendation cards within an exemplary merchant location.

### DETAILED DESCRIPTION

With reference to the figures, a system and method for providing product recommendations is hereinafter described. To this end, the system and method uses discerned relationships between products for the purpose of identifying products that are likely candidates to be purchased together by a consumer. For the products so identified, product recommendation cards 10 are created which are to be positioned within a merchant location as described in greater detail below. To discern relationships between products conventional marketing knowledge and/or data mining techniques may be used. For example and without limitation, consumer prior purchasing histories, consumer prior online viewing histories, consumer prior recommendations, etc. may be examined to discern relationships between products as described in U.S. Pat. Nos. 6,782,370, 6,912,505, 6,317,722, 6,266,649, 6,064,980, and 6,963,848 as well as U.S. Published Application Nos. 2005/0171860, 2005/0171855, and 2002/0065714. Product relationships may also be discerned by simply reviewing product requirements, e.g., batteries may be discerned to be related to smoke detectors as batteries are required for use of the smoke detector. It will also be understood that the product relationships may between specific products, categories of products, etc. without limitation.

Within a merchant location it is known to generally organize products by product category. By way of example, within a grocery store it is common to place together meats, produce, breakfast foods, snack foods, etc. Similarly, industrial merchants typically place together lighting products, plumbing products, HVAC products, power tool products, cleaning products, etc. Within such merchant locations it is also known to intersperse related products within the various categories for the purpose of increasing sales, for example by interspersing related products on shelves, shelf supports, or temporary floor displays. While this method for up-selling related products can be somewhat successful, problems exist as it is not possible to merchandise a full range of related products around any given shelf due to aesthetics and space constraints and, should product relationships change over time, it is inconvenient for the merchant to have to reorganized, replace, and/or reshelf related products within the merchant location.

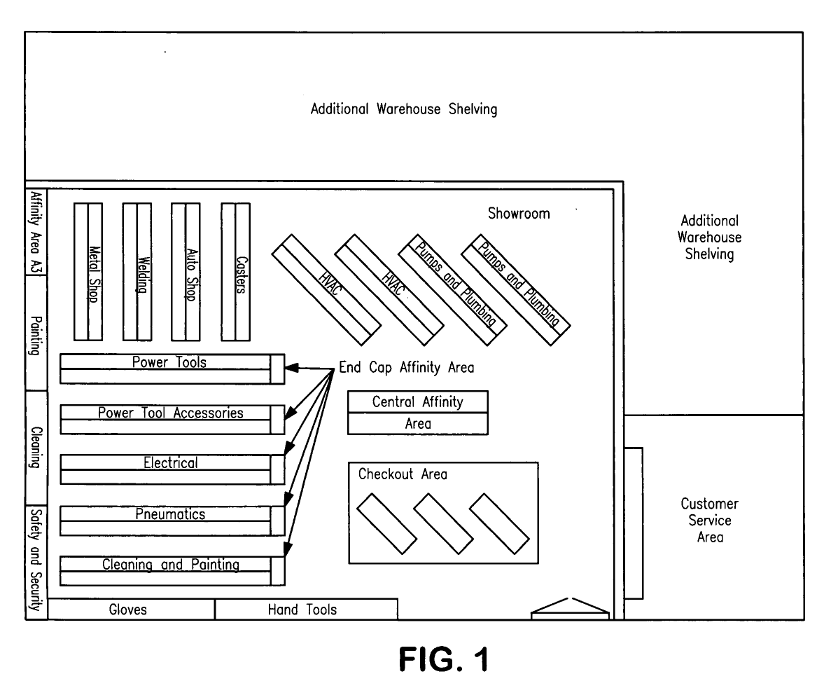

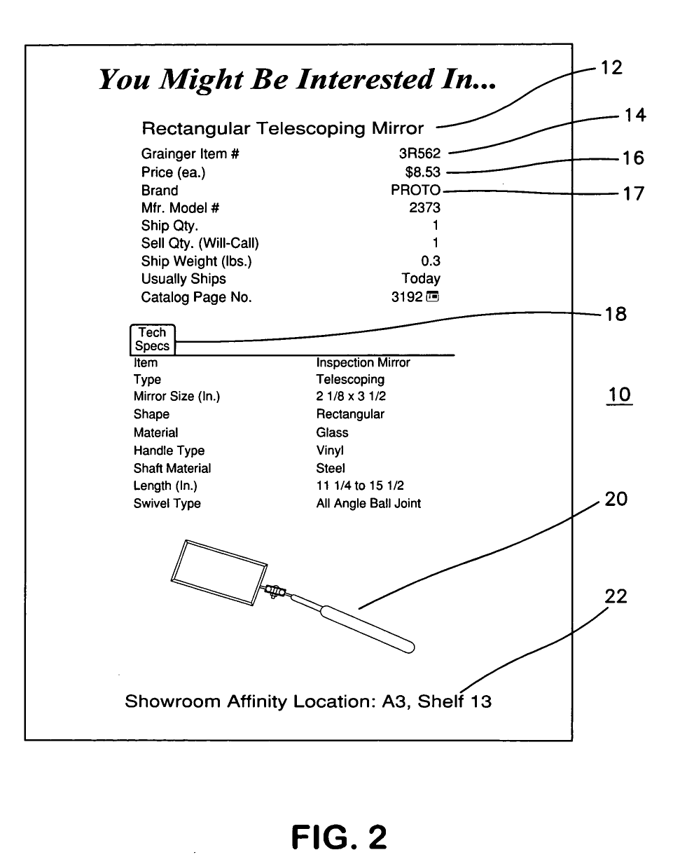

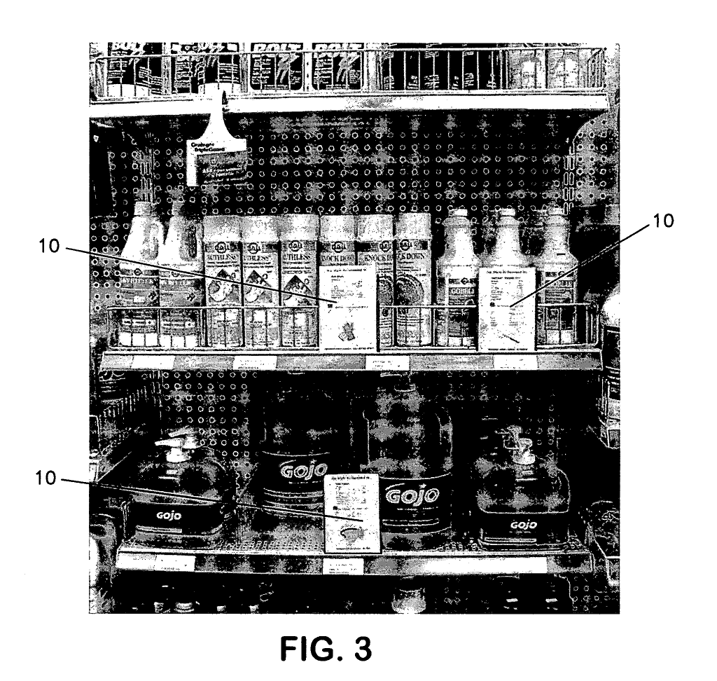

To solve these and other problems, the subject invention utilizes product recommendation cards 10, an example of which is illustrated in FIG. 2, that are to be utilized within a merchant location, an example of which is illustrated in FIG. 1. More particularly, once relationships between products are identified in any manner such as those described above, for each product within a relationship a product recommendation card 10 may be created that is to be positioned in an area of a merchant location that is associated within its related-to product. For example, if it is discerned that a carbonator pump, a rotary vane pump, a fluorescent lamp, and pipe insulation are related products, e.g., it being discerned that these products are typically purchased together (since they are commonly used together in the repair or servicing of a soft-drink vending machine), for each of these products a product recommendation card 10 may be created. To then draw the attention of a consumer to these related products, the created product recommendation card for the carbonator pump may then be positioned within the merchant location in the vicinity of rotary vane pumps, fluorescent lamps, and pipe insulation (e.g., its related-to products), the product recommendation card for the rotary vane pump may then be positioned within the merchant location in the vicinity of the carbonator pumps, fluorescent lamps, and pipe insulation (e.g., its related-to products), the product recommendation card for the fluorescent lamp may then be positioned within the merchant location in the vicinity of the carbonator pumps, the rotary vane pumps, and the pipe insulation (e.g., its related-to products), and the product recommendation card for the pipe insulation may then be positioned within the merchant location in the vicinity of the carbonator pumps, the rotary vane pumps, and the fluorescent lamps (e.g., its related-to products). By way of further example, a product recommendation card 10 for a particular product may be positioned within the merchant location in the vicinity of its related-to product by being positioned within a product recommendation card holder that is attached to shelving on which its related-to product is being displayed within the merchant location as is shown in FIG. 3.

For purposes of recommending a product to a consumer for potential purchase, the product recommendation card 10 may include for each of one or more products that are being recommended by means of the product recommendation card 10 some or all of the following information without limitation: a product name 12; a merchant and/or vendor product identifier 14 such as stock keeping unit number, bar code label, etc.; a brand name for the product 17; a price of the product 16; a specification for the product 18; and image for the product 20; and a location for the product 22 within the merchant location. Since the product recommendation card 10 may include the location for the product 22 within the merchant location, it will be appreciated that it may be desirable to provide product recommendation cards in decks which will allow a consumer to simply withdraw and carry a desired product recommendation card 10 as a reminder to move to the indicated location 22 to pick up the recommended product for purchase. It will also be appreciated that in some instances the indicated location 22 may be a centralized affinity area, an aisle affinity area, checkout affinity area, etc. within the merchant location that may, for example, shelve a number of commonly recommended products as is illustrated in FIG. 1. In still further instances, the indicated location 22 may be an area within the merchant location, such as a stock room, that would require that a consumer give a product recommendation card 10 to a merchant representative that, in turn, must retrieve the product for the consumer. The merchant location may additionally include one or more repositories for product recommendation cards, for example at the checkout, at affinity area, etc. in which product recommendation cards may be discarded by consumers for later return by the merchant to their corresponding holders.

From the foregoing, it will be appreciated that the described system and method has, among others, the advantage of allowing for an increased number of product recommendations within a merchant location. In this regard, since recommendation cards will take up less space than actual products, several recommendation cards can be positioned in the vicinity of their related-to items to spur consumer interest. Furthermore, it will be appreciated that the described system and method provides increased flexibility for merchants as it is much easier to move product recommendation cards as product relationships change over time than it is to move actual products.

While specific embodiments of the invention have been described in detail, it will be appreciated by those skilled in the art that various modifications and alternatives to those details could be developed in light of the overall teachings of the disclosure. Accordingly, the particular arrangement disclosed is meant to be illustrative only and not limiting as to the scope of the invention which is to be given the full breadth of the appended claims and any equivalents thereof.

All patent and patent applications cited within this document are hereby incorporated by reference in their entirety.

What is claimed is:

1. A method for recommending a first product to a user within a merchant location, comprising:
creating for the first product a product recommendation card which includes information relevant to the first product and a location for the first product within the merchant location; and
positioning the product recommendation card in an area within the merchant location that is in a vicinity of a second product;
wherein it was previously determined that the first product will be purchased with second product.

2. The method as recited in claim 1, wherein the information relevant to the first product comprises a picture of the first product.

3. The method as recited in claim 2, wherein the information relevant to the first product comprises a specification of the first product.

4. The method as recited in claim 3, wherein the information relevant to the first product comprises a price of the first product.

5. The method as recited in claim 3, wherein the information relevant to the first product comprises a brand name for the first product.

6. The method as recited in claim 1, wherein the product recommendation card is placed within a card holder that is located on a shelf adjacent to the second product within the merchant location.

7. The method as recited in claim 6, wherein multiple copies of the recommendation card are placed within the card holder.

8. The method as recited in claim 1, comprising placing the first product within a designated area of the merchant location which includes additional products having a product recommendation card.

9. The method as recited in claim 1, comprising mining data to discern a purchasing relationship between the first product and the second product.

10. The method as recited in claim 9, wherein the data comprises prior purchase histories of multiple consumers.

11. A method for recommending a product to a user within a merchant location, comprising:
creating for the product a product recommendation card which includes information relevant to the product and a location for the product within the merchant location; and
positioning the product recommendation card within a holder on a shelf within the merchant location that is removed from the location of the product within the merchant location.

12. The method as recited in claim 11, wherein the information relevant to the product comprises a picture of the product.

13. The method as recited in claim 12, wherein the information relevant to the product comprises a specification of the product.

14. The method as recited in claim 13, wherein the information relevant to the product comprises a price of the product.

15. The method as recited in claim 13, wherein the information relevant to the product comprises a brand name for the product.

16. The method as recited in claim 11, wherein multiple copies of the recommendation card are placed within the card holder.

17. The method as recited in claim 11, comprising placing the product within a designated area of the merchant location which includes additional products having a product recommendation card.

18. The method as recited in claim 11, comprising placing a receptacle for the product recommendation card within the merchant location whereupon the product recommendation card may be returned to the holder on the shelf.
